(19) United States
(12) Patent Application Publication
(10) Pub. No.: US 2014/0347160 A1
(43) Pub. Date: Nov. 27, 2014

(54) NAVIGATION DEVICE AND METHOD OF TRIGGERING SECURITY SETTING

(71) Applicant: PixArt Imaging Inc., Hsin-Chu City (TW)

(72) Inventors: Chun-Wei Chen, Hsin-Chu City (TW); Yen-Min Chang, Hsin-Chu City (TW)

(73) Assignee: PixArt Imaging Inc., Hsin-Chu City (TW)

(21) Appl. No.: 14/055,864

(22) Filed: Oct. 16, 2013

(30) Foreign Application Priority Data
May 27, 2013 (TW) 102118631

(51) Int. Cl. G07C 9/00

(52) U.S. Cl. CPC G07C 9/00158
USPC 340/5.53

(57) ABSTRACT

A method of utilizing a palm characteristic to trigger security setting is disclosed in the present invention. The method is applied to a navigation device, and the navigation device is used to control a computer host. The method includes obtaining the palm characteristic, comparing the palm characteristic to a predetermined value, generating a security command according to a comparison, and determining whether to lock control function of the navigation device relative to the computer host by the security command.

### BACKGROUND OF THE INVENTION

1. Field of the Invention

The present invention relates to a navigation device, and more particularly, to a navigation device and a related method of trigging security setting.

2. Description of the Prior Art

A conventional wireless mouse includes the wireless receiver disposed on the computer host, and the wireless mouse can transmit the coordinates to the computer host via the wireless receiver within an effective range of the wireless receiver, so as to execute application program of the computer host. A conventional wire mouse is connected to the computer host via the cable, and the cable can transmit the coordinates from the wire mouse to the computer host. The conventional mouse, including the wireless mouse and the wire mouse, does not have theft prevention, and then anyone takes and uses the mouse. Therefore, design of a mouse capable of utilizing the biological characteristic identifying technology to confirm license of the operator is an important issued in the related computer industry.

### SUMMARY OF THE INVENTION

The present invention provides a navigation device and a related method of trigging security setting for solving above drawbacks.

According to the claimed invention, a method of utilizing a palm characteristic to trigger security setting is disclosed. The method is applied to a navigation device, and the navigation device is for controlling a computer host. The method includes obtaining the palm characteristic, comparing the palm characteristic to a predetermined value, generating a security command according to a comparison, and determining whether a control function of the navigation device relative to the computer host is locked by the security command.

According to the claimed invention, the method of obtaining the palm characteristic includes capturing a palm photo, acquiring a linear contour of the palm photo, transforming at least one predetermined parameter of the linear contour into a line, and generating a palm print of the palm photo according to arrangement of the line.

According to the claimed invention, the method of obtaining the palm characteristic includes capturing a palm photo, acquiring at least one knuckle parameter of the palm photo, and generating a palm shape of the palm photo according to the knuckle parameter.

According to the claimed invention, the method further includes transmitting the security command to the computer host, and switching the computer host into a security saver mode by the security command when the palm characteristic does not conform to the predetermined value.

According to the claimed invention, the method further includes transmitting the security command to the computer host, and switching the computer host out of the security saver mode by the security command when the palm characteristic conforms to the predetermined value.

According to the claimed invention, a navigation device for controlling a computer host is disclosed. The navigation device includes a coordinate detecting unit, a palm characteristic detecting unit, a transmission unit and a processing unit. The coordinate detecting unit is for detecting a coordinate. The palm characteristic detecting unit is for detecting a palm characteristic. The transmission unit is connected to the computer host for signal transmission. The processing unit is electrically connected to the coordinate detecting unit, the palm characteristic detecting unit and the transmission unit. The processing unit compares the palm characteristic to a predetermined value to generate a security command, so as to determine whether control functions of the coordinate detecting unit or the transmission unit applied to the computer host are locked by the security command.

According to the claimed invention, the navigation device further includes a database connected to the processing unit for signal transmission. The predetermined value is stored inside the database. The database is disposed inside the navigation device or the computer host, or is a cloud storage unit.

The operator does not add extra action when operating the navigation device of the present invention. The operator can simultaneously execute the biological characteristic identification and use the navigation device to output the coordinate for control of the computer host. Thus, the present invention provides advantages of easy operation, low product cost, compatibility of the ordinary operational custom and the license identification, so that the navigation device of the present invention has preferred market competition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a navigation device according to an embodiment of the present invention.

FIG. 2 is a functional block diagram of the navigation device according to the embodiment of the present invention.

FIG. 3 is a flow chart of utilizing a palm characteristic to trigger security setting of the navigation device according to the embodiment of the present invention.

FIG. 4 is a flow chart of capturing a palm print according to the embodiment of the present invention.

FIG. 5 is a flow chart of capturing a palm shape according to the embodiment of the present invention.

### DETAILED DESCRIPTION

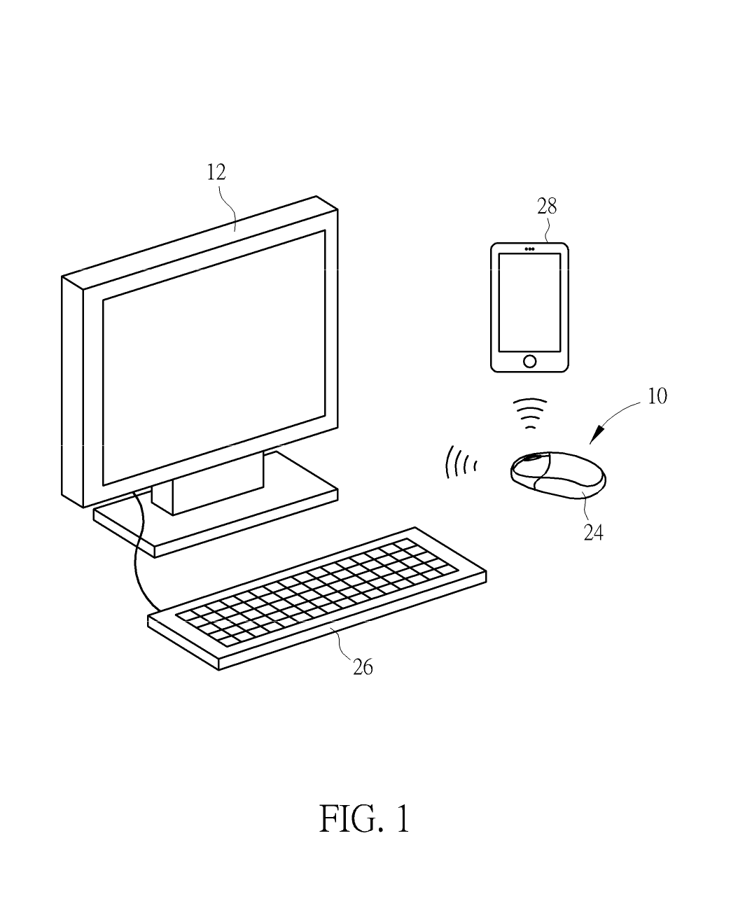

Please refer to FIG. 1. FIG. 1 is a diagram of a navigation device 10 according to an embodiment of the present invention. The navigation device 10 provides a coordinate according to the movement trace, and transmits the coordinate to a computer host 12 for executing the related application program of the computer host 12. Generally, the navigation device 10 can be a mouse, a track ball, a touch pad and the related input devices. The navigation 10 can transmit the coordinate in the wire transmission manner or in the wireless transmission manner. The navigation device 10 has features of slight volume and convenient portability, the input devices may be operated by the unlicensed operator and loses classified information. Therefore, the navigation device 10 of the present invention can identify the biological characteristic of the operator to determine whether the license is allowable, so as to provide preferred security protection.

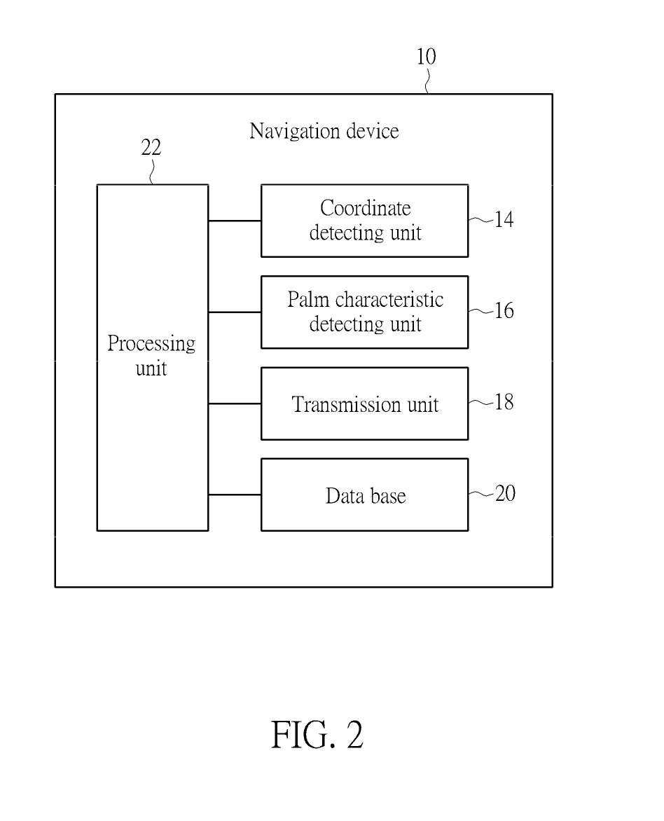

Please refer to FIG. 2. FIG. 2 is a functional block diagram of the navigation device 10 according to the embodiment of the present invention. The navigation device 10 includes a coordinate detecting unit 14, a palm characteristic detecting unit 16, a transmission unit 18, a data base 20 and a processing unit 22. The coordinate detecting unit 14 utilizes an optical signal or rotation of the roller to detect coordinate variation during movement of the navigation device 10. The palm characteristic detecting unit 16 captures a palm photo of the operator when the palm of the operator covers the navigation device 10. The palm characteristic detecting unit 16 can acquire the palm print or the palm shape for identification according to its unique feature. Comparing to the other biological characteristic identifying technology, such as the finger print identification, the palm characteristic detecting unit 16 has advantages of low cost and rapid execution.

As shown in FIG. 1 and FIG. 2, the navigation device 10 further includes a casing 24 for covering the coordinate detecting unit 14, the palm characteristic detecting unit 16, the transmission unit 18 and the processing unit 22 for dust-proof protection. The casing 24 can be made of transparent material. An optical detecting signal generated from the palm characteristic detecting unit 16 passes though the casing 24 to capture the palm characteristic of the operator which is put on the casing 24. The optical detecting signal can be visible light or invisible light. For example, the casing 24 can be made of dark material pervious to light, and the optical detecting signal can be an infrared signal.

The transmission unit 18 is connected to the computer host 12 for signal transmission. The transmission unit 18 can transmit the coordinate detected by the coordinate detecting unit 14 and the palm characteristic detected by the palm characteristic detecting unit 16 to the computer host 12 for analysis. The computer host 12 accordingly includes the signal receiving unit matched with the transmission unit 18 for the signal transmission, and a detailed description is omitted herein for simplicity. The transmission unit 18 can be the wire transmission unit, the wireless transmission unit or the communication network unit, which utilize 2.4G wireless interface, Bluetooth interface, USB interface, internet or mobile communication to transmit the coordinate and the palm characteristic to the computer host 12. Application of the transmission unit 18 is not limited to the above-mentioned embodiments, and depends on design demand.

The database 20 is connected to the processing unit 22 for the signal transmission. A predetermined value is the palm characteristic of the licensed operator and can be stored inside the database 20. The processing unit 22 can connect the database 20 to read the predetermined value, and compare the predetermined value with the detected palm characteristic for biology characteristic identification. In addition, the database 20 can be disposed inside the navigation 10 or the computer host 12 alternatively, or can be a cloud storage unit disposed on the remote server selectively. Application of the database 20 is not limited to the above-mentioned embodiments, and depends on actual demand.

The processing unit 22 is electrically connected to the coordinate detecting unit 14, the palm characteristic detecting unit 16, the transmission unit 18 and the database 20. The processing unit 22 can generate a security command according to a comparison of the palm characteristic and the predetermined value, so as to determine whether control functions of the coordinate detecting unit 14 or the transmission unit 18 applied to the computer host 12 is locked. For example, the operator is unlicensed when the palm characteristic does not conform to the predetermined value, the processing unit 22 can stop detect function of the coordinate detecting unit 14, or stop output function of the transmission unit 18 (stop transmitting the coordinate to the computer host 12). The processing unit 22 further can switch the computer host 12 into a security saver mode according to the security command, such as procedures of locking operation of the computer host 12 or deleting a specific file of the computer host 12 automatically.

Besides, the operator is licensed when the palm characteristic conforms to the predetermined value, the processing unit 22 can recover the output function of the transmission unit 18 to transmit the coordinate to the computer host 12, and further can switch the computer host 12 out of the security saver mode according to the security command, such as procedures of releasing an operation constraint of the computer host 12 or decrypting the specific file of the computer host 12 automatically. Content of the security command is not limited to the above-mentioned embodiments, which depends on design demand, and the detailed description is omitted herein for simplicity.

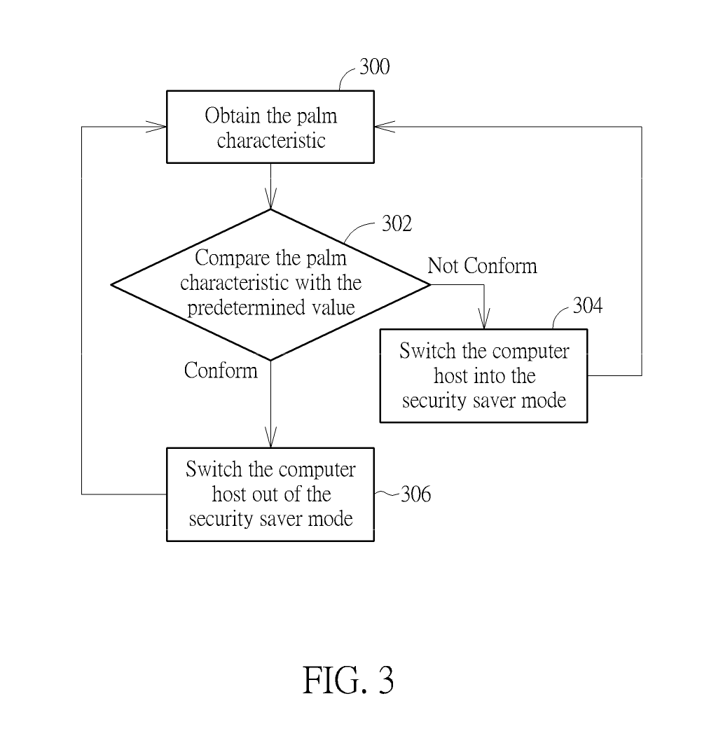

Please refer to FIG. 3. FIG. 3 is a flow chart of utilizing the palm characteristic to trigger security setting of the navigation device 10 according to the embodiment of the present invention. The method of trigger the security setting illustrated in FIG. 3 is suitable for the navigation device 10 shown in FIG. 1 and FIG. 2. First, step 300 is executed to actuate the palm characteristic detecting unit 16 to obtain the palm characteristic, which means the operator's palm is put on the casing 24, and the palm characteristic detecting unit 16 outputs the optical detecting signal to detect the palm print or the palm shape of the operator. Then, step 302 is executed that the processing unit 22 connects the database 20 to read the predetermined value and compares the palm characteristic detected by the palm characteristic detecting unit 16 with the predetermined value. Step 304 is executed when the palm characteristic does not conform to the predetermined value. The processing unit 22 generates and transmits the security command to the computer host 12, to switch the computer host 12 into the security saver mode; meanwhile, the palm characteristic detecting unit 16 still obtains the latest palm characteristic, to determine whether the computer host 12 is set on the security saver mode. Step 306 is executed when the palm characteristic conforms to the predetermined value. The processing unit 22 generates the other security command. The processing unit 22 transmits the said security command to the computer host 12, and the computer host 12 is switched out of the security saver mode and into the normal mode; meanwhile, the palm characteristic detecting unit 16 still obtains the latest palm characteristic, to determine whether the computer host 12 is set on the normal mode.

Before actuation, the navigation device 10 of the present invention can detect whether the palm characteristic of the operator is licensed, and generate the corresponding security command to determine whether the control function of the navigation device 10 relative to the computer host 12 is locked or unlocked. When the navigation device 10 switches the computer host 12 into the security saver mode, the processing unit 22 may lock the operation of the computer host 12, delete the specific file of the computer host 12, or shut down the screen to prevent secret from disclosure by the security command. As the computer host 12 is electrically connected to an input device 26, such as the keyboard shown in FIG. 1, the processing unit 22 further can control the computer host 12 to stop receiving an input signal from the input device 26 by the security command, so that the unlicensed operator can not utilize any input device to transmit the control command to the computer host 12, to effectively prevent the files inside the computer host 12 from copy, delete or read. Furthermore, when the detected palm characteristic does not conform to the predetermined value, the processing unit 22 utilizes the transmission unit 18 to output a reminder signal to an external communication device 28, such as the mobile phone shown in FIG. 1. The navigation device 10 can transmit the warning message to the mobile phone of the related licensed operator, to remind the unusual situation of the navigation device 10 and to effectively prevent information of the navigation device 10 from steal or damage.

When the navigation device 10 switches the computer host 12 into the normal mode (exit from the security saver mode), the processing unit 22 can release the operation constraint of the computer host 12 or decrypt the specific file of the computer host 12 by the security command. As the computer host 12 is electrically connected to the input device 26, the processing unit 22 can utilize the security command to drive the computer host 12 to receive the input signal from the input device 26, and the licensed operator can conveniently utilize peripheral equipments of the computer host 12 to input the control command. In addition, the navigation device 10 not only can store the palm characteristic of the licensed operator, but also can store personal information (such as login information) of each licensed operator. When the navigation device 10 determines the operator is licensed, the processing unit 22 can selectively utilize the transmission unit 18 to output the personal information related to the palm characteristic to the computer host 12, such as an account and password of email box, so as to drive the computer host 12 automatically actuate the related application program for preferred operational convenience.

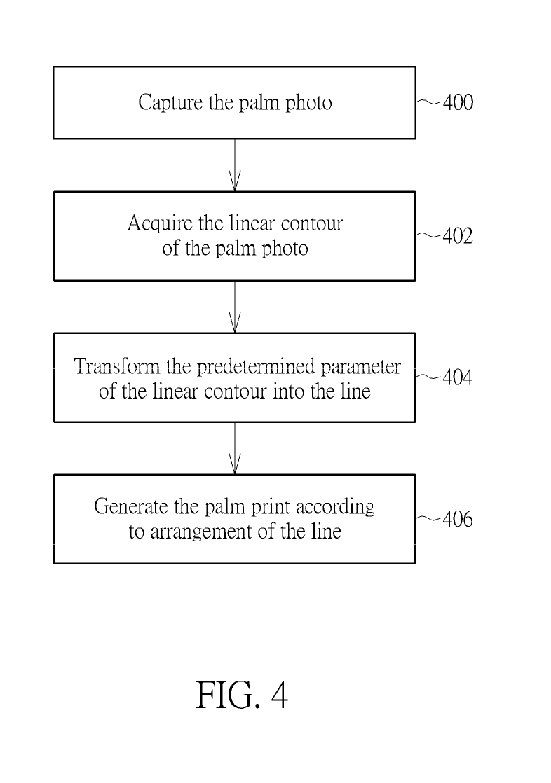

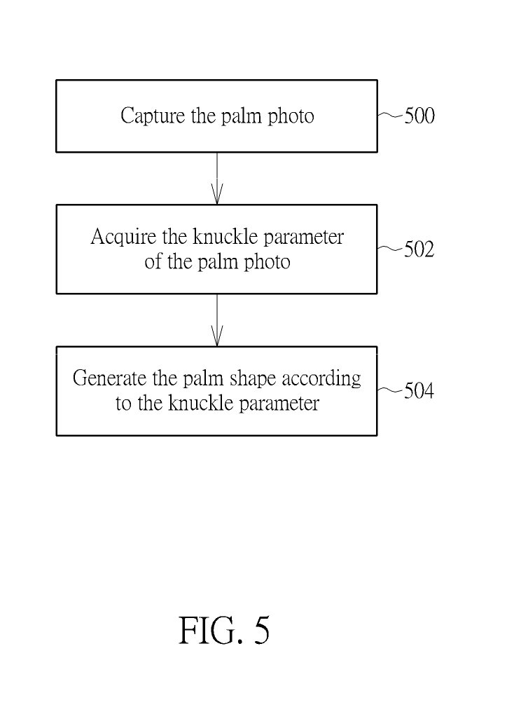

It should be mentioned that the method of obtaining the palm characteristic applied to the navigation device 10 of the present invention can include the methods of capturing the palm print and capturing the palm shape. Please refer to FIG. 4 and FIG. 5. FIG. 4 is a flow chart of capturing the palm print according to the embodiment of the present invention. FIG. 5 is a flow chart of capturing the palm shape according to the embodiment of the present invention. The capturing methods illustrated in FIG. 4 and FIG. 5 are suitable for the navigation device 10 shown in FIG. 1 and FIG. 2. As shown in FIG. 4, step 400 is executed to capture the palm photo of the operator by the palm characteristic detecting unit 16. Then, step 402 to step 406 are executed that the processing unit 22 acquires the linear contour of the palm photo, and transforms at least one predetermined parameter of the linear contour into a line, so as to generate the palm print according to arrangement of the line. The processing unit 22 analyzes the print feature of the palm photo, and the palm characteristic detecting unit 16 can obtain the accurate palm print via the palm photo with low resolution.

The method of capturing the palm shape is illustrated in FIG. 5. Step 500 is executed and the palm characteristic detecting unit 16 captures the palm photo. Step 502 and step 504 are executed that the processing unit 22 acquires at least one knuckle parameter of the palm photo, and generates the palm shape of the palm photo according to the knuckle parameter. The processing unit 22 mainly measures shapes and dimensions of the palm photo, or simply measures a length and a width of each finger to calculate the relative distance of each knuckle to the others. Amount of measurement data of this method can be abated to effectively decrease the product cost and increase the identification speed. Further, the palm characteristic detecting unit 16 can utilize the 3D image transformation technology to calculate stereo features of the palm photo, such as thickness of the finger and the palm, for being the palm characteristic parameters of the biological identification.

In conclusion, the present invention executes the palm characteristic identification when the operator uses the navigation device. The operation constraints of the navigation device, the computer host and the related peripheral equipments are released as the biological identification passes, or the partially operation constraints of the navigation device, the computer host and the related peripheral equipments are released according to an allowable level of the licensed operator. As the biological identification fails, the navigation device locks the operations of the navigation device, the computer host and the related peripheral equipments, to prevent the information inside the computer host from steal by the unlicensed operator. The navigation device can utilize the own processing unit to execute identification calculation, or connect to the computer host and the identification calculation is executed by the computer host, or connect to the cloud server and the identification calculation is executed by the cloud server. Therefore, connection between the navigation device and the computer host can be opened after the navigation device or the computer host executes the biological identification, or the cloud server unlocks the operation of the computer host after the cloud server executes the biological identification. Application of the present invention is not limited to the above-mentioned embodiments, and depends on design demand.

Comparing to the prior art, the operator does not add extra action when operating the navigation device of the present invention. The operator can simultaneously execute the biological characteristic identification and use the navigation device to output the coordinate for control of the computer host. Thus, the present invention provides advantages of easy operation, low product cost, compatibility of the ordinary operational custom and the license identification, so that the navigation device of the present invention has preferred market competition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of utilizing a palm characteristic to trigger security setting, the method being applied to a navigation device, and the navigation device being for controlling a computer host, the method comprising:
obtaining the palm characteristic;
comparing the palm characteristic to a predetermined value;
generating a security command according to a comparison; and
determining whether a control function of the navigation device relative to the computer host is locked by the security command.

2. The method of claim 1, wherein the navigation device outputs a coordinate to the computer host when the palm characteristic conforms to the predetermined value, the navigation device does not output the coordinate to the computer host when the palm characteristic does not conform to the predetermined value.

3. The method of claim 1, wherein the method of obtaining the palm characteristic comprises:
capturing a palm photo;
acquiring a linear contour of the palm photo;
transforming at least one predetermined parameter of the linear contour into a line; and
generating a palm print of the palm photo according to arrangement of the line.

4. The method of claim 1, wherein the method of obtaining the palm characteristic comprises:
capturing a palm photo;
acquiring at least one knuckle parameter of the palm photo; and
generating a palm shape of the palm photo according to the knuckle parameter.

5. The method of claim 1, further comprising:
transmitting the security command to the computer host; and
switching the computer host into a security saver mode by the security command when the palm characteristic does not conform to the predetermined value.

6. The method of claim 5, wherein the security saver mode of the computer host comprises procedures of locking operation of the computer host or deleting a specific file of the computer host by the security command.

7. The method of claim 5, wherein the computer host is electrically connected to an input device, the security command further controls the computer host to stop receiving an input signal from the input device.

8. The method of claim 5, further comprising:
outputting a reminder signal to an external communication device.

9. The method of claim 1, further comprising:
transmitting the security command to the computer host; and
switching the computer host out of the security saver mode by the security command when the palm characteristic conforms to the predetermined value.

10. The method of claim 9, wherein the computer host switched out of the security saver mode comprises procedures of releasing an operation constraint of the computer host or decrypting a specific file of the computer host by the security command.

11. The method of claim 9, wherein the computer host is electrically connected to an input device, the security command further controls the computer host to receive an input signal from the input device.

12. The method of claim 9, further comprising:
outputting login information related to the palm characteristic to actuate an application program of the computer host.

13. The method of claim 1, further comprising:
connecting a database to read the predetermined value.

14. The method of claim 13, wherein the database is disposed inside the navigation device or the computer host, or is a cloud storage unit.

15. The method of claim 1, wherein the navigation device utilizes wire transmission, wireless transmission or communication network to transmit the security command to the computer host.

16. A navigation device for controlling a computer host, the navigation device comprising:
a coordinate detecting unit for detecting a coordinate;
a palm characteristic detecting unit for detecting a palm characteristic;
a transmission unit connected to the computer host for signal transmission; and
a processing unit electrically connected to the coordinate detecting unit, the palm characteristic detecting unit and the transmission unit, the processing unit comparing the palm characteristic to a predetermined value to generate a security command, so as to determine whether control functions of the coordinate detecting unit or the transmission unit applied to the computer host are locked by the security command.

17. The navigation device of claim 16, wherein the navigation device outputs a coordinate to the computer host via the transmission unit when the palm characteristic conforms to the predetermined value.

18. The navigation device of claim 16, wherein the coordinate detecting unit does not detect the coordinate or the transmission unit does not output the coordinate to the computer host when the palm characteristic does not conform to the predetermined value.

19. The navigation device of claim 16, wherein the palm characteristic detecting unit obtains a palm print or a palm shape of the palm characteristic.

20. The navigation device of claim 16, wherein the computer host is switched into a security saver mode by the security command when the processing unit determines the palm characteristic does not conform to the predetermined value.

21. The navigation device of claim 20, wherein the processing unit locks operation of the computer host or deletes a specific file of the computer host by the security command.

22. The navigation device of claim 20, wherein the computer host is electrically connected to an input device, the processing unit controls the computer host to stop receiving an input signal from the input device by the security command.

23. The navigation device of claim 20, wherein the processing unit utilizes the transmission unit to output a reminder signal to an external communication device.

24. The navigation device of claim 16, wherein the computer host is switched out of the security saver mode by the security command when the processing unit determines the palm characteristic conforms to the predetermined value.

25. The navigation device of claim 24, wherein the processing unit releases an operation constraint of the computer host or decrypts a specific file of the computer host by the security command.

26. The navigation device of claim 24, wherein the computer host is electrically connected to an input device, the processing unit controls the computer host to receive an input signal from the input device by the security command.

27. The navigation device of claim 24, wherein the processing unit utilizes the transmission unit to output login information related to the palm characteristic to actuate an application program of the computer host.

28. The navigation device of claim 16, further comprising:
a database connected to the processing unit for signal transmission, the predetermined value being stored inside the database, wherein the database is disposed inside the navigation device or the computer host, or is a cloud storage unit.

29. The navigation device of claim 16, wherein the transmission unit is a wire transmission unit, a wireless transmission unit or a communication network unit.
